(19) United States
(12) Patent Application Publication
(10) Pub. No.: US 2013/0046796 A1
(43) Pub. Date: Feb. 21, 2013

(54) VIRTUAL PARTICIPANT FOR A SHARED MEDIA SESSION

(71) Applicants: Nazin HOSSAIN, Brossard (CA); Stefan Paul REDMOND, Pointe-Claire (CA)

(72) Inventors: Nazin HOSSAIN, Brossard (CA); Stefan Paul REDMOND, Pointe-Claire (CA)

(73) Assignee: TELEFONAKTIEBOLAGET L M ERICSSON (PUBL)

(21) Appl. No.: 13/212,798

(22) Filed: Aug. 18, 2011

(51) Int. Cl. G06F 7/00; G06F 3/048

(52) U.S. Cl. 707/803; 715/747; 707/E17.044; 707/E17.119

(57) ABSTRACT

A virtual participant profile is created in a manner that allows for an individual user's contribution to be identified so that modifications for new users joining, existing users leaving, and existing users changing their profiles will not require that the entire virtual participant profile is regenerated from the individual profiles.

### TECHNICAL FIELD

This disclosure is directed to mechanisms for modeling the behavior and preferences of a plurality of users. In particular the disclosure is directed to the creation of a virtual participant that models common features of real participants in a session.

### BACKGROUND

As broadcast media developed, it was, for numerous reasons, a social experience. At first technological and financial reasons made television, and before it radio, necessitated that the content consumed was consumed as a group and selection of the content was often nothing more than taking the one available content stream.

At first music was made both personal and portable, first with the development of record players and transistor radios, then television followed slowly and fitfully followed. Televisions became smaller, and distribution technology progressed from over the air broadcast, to over cable broadcast, and is now progressing to digital distribution that allows for content on demand to be delivered to content consumers through data packet networks, over both wired and wireless networks.

Media distribution in a digital delivery system allows users to select content to be consumed on demand. In combination with greater personalization of the delivery platform, this has lead to a private content consumption experience. Often in a single household, each member of the household will be in different rooms of the house consuming different content.

These same technologies that have removed the social aspect have also provided for a number of new communication paths. Instant messaging and voice messaging have been enabled on the same devices that are used for the content creation. In this manner, a new form of social viewing is developing. Instead of families gathered around a television watching a program, groups of friends can virtually gather to watch selected content.

This has lead to a number of new challenges, including the actual selection of content in a content on demand environment. As the size of a group increases the ability of the group to reach a consensus on the selection of content typically diminishes. The group members can be geographically spread out, can have different viewing preferences and can have different viewing histories. This makes it difficult to select content with the typically large content libraries available.

In the existing art, content recommendation engines are used to recommend suggested content.

In one example of the prior art, a content recommendation engine is employed when a user visits an electronic commerce site. When the user visits a page related to a particular product, the merchant recommends content based on a correlation between the displayed content and purchases made by other users who also bought the displayed content. Thus when viewing a book, a user is typically shown a recommendation based on the purchasing habits of other users. Although this takes into account the behavior of people who may have an interest in the same product it does not account for the particular interests of the user. If a user is partial to a particular music genre, for example operatic arias, but is looking for a gift and is looking at an album in another genre, for example heavy metal, receiving suggestions based on the buying history of heavy metal purchasers may be less than useful.

Such recommendation engines have progressed to base recommendations on a user profile. If a user's content consumption history is stored, it can be compared to the histories of other users. This allows a recommendation engine to correlate preferences across a number of users to provide more relevant recommendations.

Problems arise when more than one user is to be accounted for when suggestions are to be made. For example, if a group of people, each having a profile, are to select a single movie to watch, it becomes difficult to accommodate a wide variety of tastes. To address this, a number of solutions that utilize a plurality of user profiles have been proposed.

“TV program recommendation for multiple viewers based on user profile merging” by Yu et al. published on 10 Jun. 2006, provides both an overview of previous solutions and a suggestion for an improvement over the previous solutions. Taken as a whole, this paper teaches, as illustrated in FIG. 1, that a plurality of user profiles 50 are provided to common profile generator 52, which combines the characteristics of each of the users to create a common profile 54. This can be done in a number of different ways including the use of a multi-dimensional calculation to determine a set of characteristics that minimize the overall missed distance between the determined profile 54 and each of the user profiles 50a 50b and 50c. This common profile 54 can then be provided to a standard recommendation engine 56. In conjunction with the common profile 54 and the available catalogue of content 58, recommendation engine 52 can provide a set of suggestions 60.

FIG. 2 provides a more detailed example of a common profile 54. Profile 54 includes a combined view history 54.2 that encompasses what movies have already been viewed by the users that contributed to the profile. A set of combined demographic information 54.4 can be used to determine which content is targeted to the demographic profile of the group, while combined user dislikes 54.6a and user preferences 54.6b can be created to take into account the preferences and dislikes of the users (e.g. a preference towards action movies, or a dislike of a black and white movies). Combined actor ratings 54.8a and director ratings 54.8b can also form part of the profile.

Although the generation of a common profile addresses some of the problems of selecting content for a group of people, it creates a number of other problems. In creating a social experience, it is often advantageous to invite a plurality of people to participate. As people indicate that they will participate, the number of profiles increases. With the above described solution an interesting problem occurs. During the invitation period it may be preferable to provide either the single suggested movie or a set of suggestions. However, as people respond to the invitation and indicate that they will participate; this requires that the common profile be re-generated. During the invitation period, people can also withdraw from the event, which also requires that the common profile be regenerated. Based on the particular manner in which the profile is generated, the arrival or departure of some participants may greatly change the suggestions. As the number of participants in the event grows, recomputing the common profile becomes a non-trivial activity, especially when the individual user profiles are large and content rich.

Furthermore, it should be understood that different participants need their preferences handled differently. The viewing history, for example, can contain both a listing of the movies seen by a user and a user assigned rating. For some users, the fact that they have seen a movie a strong reason to not want to see the movie again. For other users, watching a movie that has already been seen is not a problem, and it is the rating assigned to moves that is a bigger issue. In the above described solutions, every user is treated the same, and to a certain extent is robbed of the individual preferences. This could reduce the effectiveness of the recommendation system just as the above described problems reduce the efficiency of the recommendation system in a dynamic group environment.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a storage for a virtual participant profile. The storage stores preferences associated with a plurality of users that are participating in an event. The profile storage comprising a memory for storing a plurality of profile elements, each of the plurality of profile element storing both a composite element value determined in accordance with a corresponding element value associated with at least one of the users in the plurality of users, and an indication identifying the contribution that the at least one of the users had to the composite value.

In one embodiment of the first aspect, at least one of the plurality of profile elements is used to store information related to at least one of a composite demographic profile, a composite viewing history, a composite preference, a composite dislike, and a composite rating. The composite rating can be associated with one of an actor, a director and a movie. The composite preference and composite dislike may be user defined.

In a second aspect of the present invention, there is provided a method of generating a virtual participant profile associated with an event. The method comprises the steps of receiving, through a network interface, an indication that an event has been initialized;

receiving a first profile associated with both a user and the event; creating a virtual participant profile associated with the event, the profile having both at least one profile element storing a composite value determined in accordance with an associated element in the received first profile and an indication identifying the contribution of the user associated with the first profile to the composite value; and storing the created virtual participant profile in a memory.

In an embodiment of the second aspect of the present invention, the step of receiving an indication includes receiving a request from a user over a network interface to initialize the event and creating a data structure to store data associated with the event. In another embodiment, the step of receiving a first profile includes receiving, through a network interface from a user, confirmation of involvement in the event; and in response to the receipt of the confirmation, retrieving from a database a user profile associated with the user associated with the received confirmation. In a further embodiment, creating the virtual participant profile is done in accordance with both the associated element and information associated with the event provided with the indication. In yet a further embodiment, the method can further include the steps of receiving information relevant to the stored virtual participant profile; and modifying the stored virtual participant profile in accordance with the received relevant information.

In a third aspect of the present invention, there is provided a method of modifying an existing virtual participant profile representing a plurality of users and stored in a memory. The method comprises the steps of retrieving the stored virtual participant profile from a memory in response to receipt of information relevant to the stored profile; identifying an element of the retrieved profile associated with the received information; adjusting a value of the identified element in accordance with its existing value, contributions associated with at least a portion of the plurality of users and the received information; and storing the adjusted value as part of the modified virtual participant profile in the memory.

In an embodiment of the third aspect, the received information relevant to the stored profile is a profile associated with a user joining the plurality. Optionally, the step of adjusting further includes adjusting the value in accordance with a weighted average, and the step of identifying can include determining that an element of the received user profile has no corresponding element in the retrieved virtual participant profile; and creating an element in the virtual profile associated with the determined element in the received user profile.

In a further embodiment, the received information relevant to the stored profile is a modification of a profile associated with a user in the plurality. Optionally, the the step of identifying includes identifying an element in the modified user profile that has changed; and identifying the element in the retrieved profile associated with the changed element. Additionally, the step of identifying may include determining that the modified user profile has a new element; determining that the new element in the user profile is not associated with an element in the virtual participant profile; and creating an element in the virtual participant profile associated with the new element in the user profile.

In a further embodiment, the received information is an indication that a user is withdrawing from the plurality. Optionally, the step of identifying includes selecting all elements in the virtual participant profile having an associated indication identifying a contribution by the withdrawing user; and the step of adjusting includes removing the contribution associated with the withdrawing user from all selected elements. In a further embodiment, the method further includes transmitting updated information associated with the profile of the withdrawing user for storage in a user profile database where the updated information may be determined in accordance with information stored in the virtual participant profile.

In a further embodiment, the step of adjusting the value includes associating the received information with one of the users in the plurality. Optionally, the step of adjusting also includes storing an indication associated with the value to reflect the user in the plurality associated with the received information.

In a fourth aspect of the present invention, there is provided a virtual participant profile generator for generating and modifying a virtual participant profile associated with an event. The generator comprises a participant request interface, a user profile interface and a processor. The participant request interface for receiving from users request to join or leave the event. The user profile interface for communicating with a user database storing user profiles. The processor for generating the virtual participant profile in response to receipt of a user request to join the event in accordance with receipt of a user profile associated with the requesting user, the generated profile storing an indication of user contribution to at least one element of the profile, and for modifying an already generated virtual profile in accordance with a second user request to join an event or a user request to withdraw from an event.

In an embodiment of the fourth aspect of the present invention, the profile generator includes an external data interface for receiving information relevant to the virtual participant profile, and for transmitting the received information to the processor. In a further embodiment, the generator includes a virtual profile interface for receiving an already generated virtual participant profile and for transmitting the received profile to the processor for modification.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a recommendation system of the prior art;

FIG. 2 is an illustration of an exemplary common profile of the prior art;

FIG. 3 is an exemplary illustration of a user profile for use by a recommendation system;

FIG. 4 is a block diagram illustrating a system for generating a virtual participant profile;

FIG. 5 is an exemplary illustration of a virtual participant profile;

FIG. 6 is a flowchart illustrating an exemplary method of creating and modifying a virtual participant profile;

FIG. 7 is a flowchart illustrating an exemplary embodiment of the method shown in FIG. 6;

FIG. 8 is a flowchart illustrating an exemplary embodiment of the method shown in FIG. 6;

FIG. 9 is a flowchart illustrating an exemplary embodiment of the method shown in FIG. 6;

FIG. 10 is a flowchart illustrating an exemplary embodiment of the method shown in FIG. 6; and

FIG. 11 is a flowchart illustrating an exemplary embodiment of the method shown in FIG. 6.

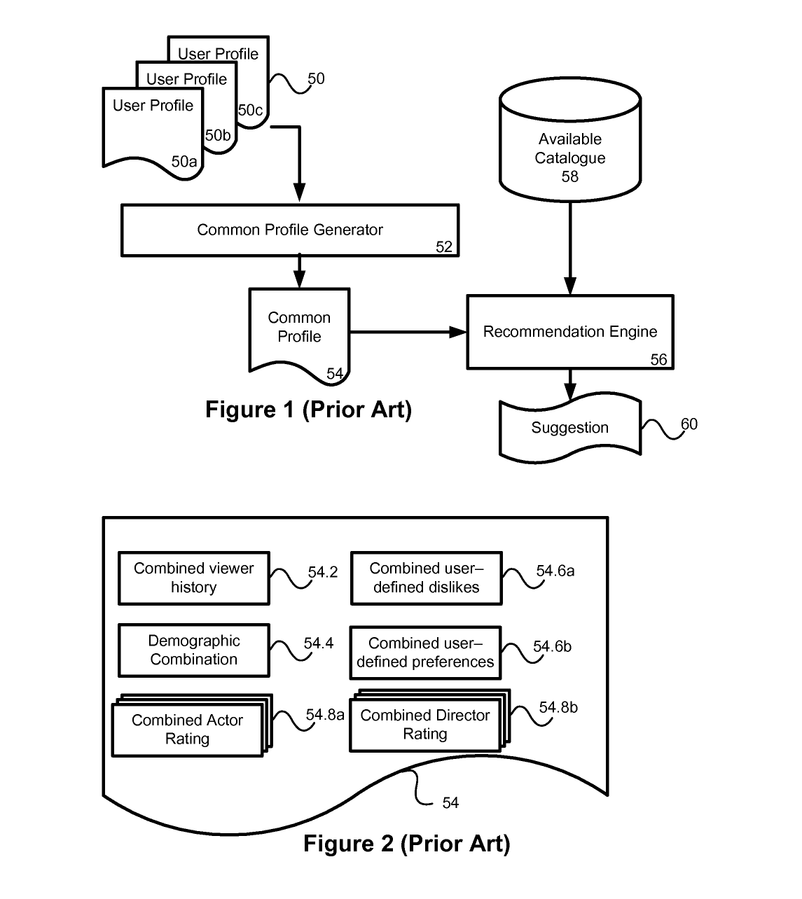

### DETAILED DESCRIPTION

The present invention is directed to a system and method for the generation of a virtual participant profile for use in a dynamic group environment.

In observing group behavior, it becomes apparent that different users put weight in different areas of their profile. Although the teachings of Yu et al. allow different components of the profiles to be weighted differently in the minimization of the missed distance, this is a global weighting. It still results in all users being treated the same. Further observations of group behavior show that when provided a long window in which to join a group, people join and a variety of different times, and occasionally, people leave the group. The departure of a person from an established group can result in a sufficiently different group profile and accordingly a different set of movie selections could be offered. For example, if a particular user has a very strong preference to not see movies that he has seen recently leaves a group, the recommendation could change to suggest one of the movies that that user had recently seen. Those skilled in the art will appreciate that although the following discussion is centered around the example of a group of people gathering together (either gathering physically or virtually) to watch a movie, the consumption of content is not limited to selecting movies. The virtual participant profile discussed below can be used in the selection of other content including targeted advertising, television programming, music and music videos.

In the following discussion, mechanisms for allowing a user to provide further customization to a profile to reflect the relative importance of different factors will be described in the context of the creation of a profile that is assigned to a virtual participant. The virtual participant is considered to be representative of the overall group, and provides a balanced approach to finding a common ground among the participants.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

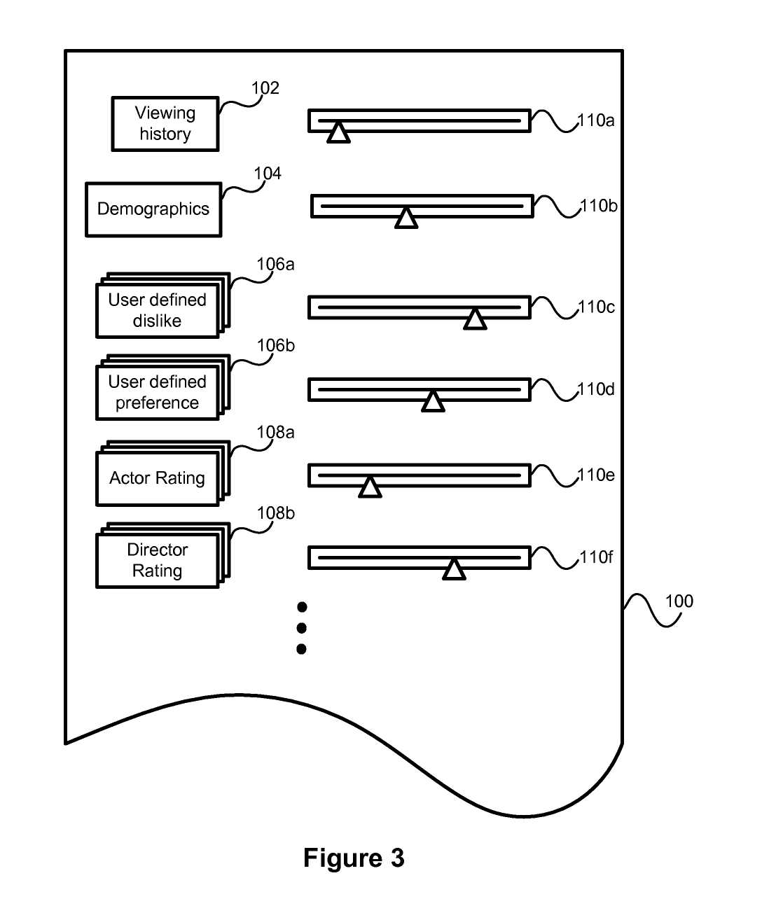

FIG. 3 illustrates a user profile 100 made up of constituent data elements such as the viewing history 102, demographic information 104, user defined dislikes 106a, user defined preferences 106b, actor ratings 108a director ratings 108b, and other such information as will be apparent to those skilled in the art. In addition, the user is able to define a personalized set of weights that are associated with elements of the user profile. Illustrated here as weighting values 110a-110f, the user can be provided with a number of ways to indicate which elements in the profile are more important than others. In the illustrated example, the user defined dislike weighting value 110c than the viewing history weighting value 110a. This may indicate for example, that a user defined dislike (e.g. movies with subtitles) is more important than whether or no the user has seen a particular movie before. By allowing each user the ability to define the weights of likes and dislikes, this user profile is more useful in generating content recommendations for the individual as well as in the context of the group.

The following discussion of the generation of a virtual participant profile will be provided in the context of a social event organized with the intention of having a group of people watch a movie together. One skilled in the art will appreciate that the participants need not be at the same location when watching the movie, and that either the enhanced user profile illustrated in FIG. 3, or another user profile can be used without departing from the scope of the present invention. The manner in which the event is organized will be discussed below in the context of using a social media site for organization. This is not to be considered as limiting the use of the invention to events organized using social media, instead this is used as an example to provide readers with sufficient context to appreciate many of the advantages of the invention.

A first user decides to act as the host of a movie night. Instead of simply calling and emailing friends to inform them of the event, and then trying to arrange for everyone to select a movie, an invitation is issued to a group. The invitation can be emailed, or it can be delivered through one or more social media services. The recipients of the invitation are able to RSVP to the event to confirm attendance, and at the same time are able to provide their user profile as a contribution to the virtual participant profile that can then be used to generate a series of recommendations. During the week before the event, a variety of people join the event, increasing the number of user profiles contributed. As new users join, the virtual participant profile is modified, and the participants (and possibly even the invitees) are able to see what the movie suggestions are. As each user joins and the virtual participant is modified, the suggested movies can be updated. If a social media service has been employed, a discussion about the movie night in a forum associated with the invitation can be used as an input to further refine the characteristics of the virtual participant (e.g. if a user comments that there have been bad reviews on a particular movie, the profile could down prioritize that movie by creating preferences and dislikes that account for the comment). During the time between the issuance of the invitation and the final selection of a movie, a user can also watch other movies which would result in changes to the user's profile (e.g. at least the viewing history would change). These changes can be accommodated and reflected in the virtual participant profile. If a user has replied to the invitation, but later has to cancel, the user's contribution to the virtual participant profile can be adjusted.

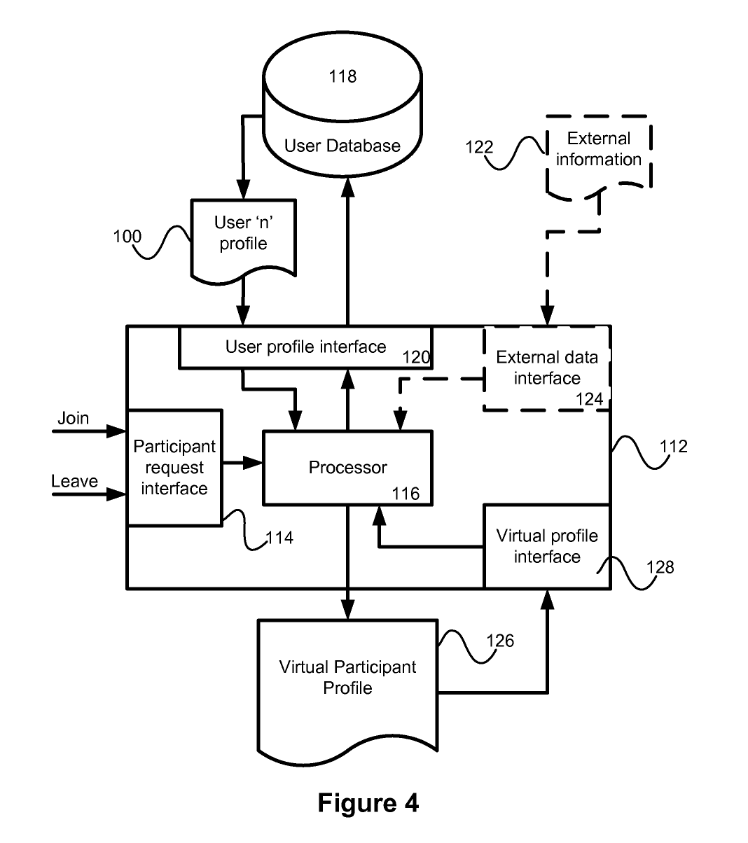

FIG. 4 illustrates an exemplary embodiment of a virtual participant profile generator 112 of the present invention. Generator 112 receives user requests through participant request interface 114. These requests are relayed to processor 116 where they are acted upon. When implemented, the participant request interface may be a network interface for receiving and handling user requests. If a user request to join a session does not include the profile, processor 118 can access user database 118 through user profile interface 120 to retrieve the profile 100 of the user joining the session. The retrieved profile is then used by the processor in the creation of the virtual participant profile 126. The virtual participant profile 126 will be illustrated and discussed in greater detail below. External information 122, including information explicitly associated with the event (e.g. if the event was created as an “Action Movie” night, this external information would be embedded into the virtual participant profile), and implicitly provided information (e.g. information obtained from observing a participant discussion of the event), is received by generator 112 through external data interface 124, and is provided to processor 116 which can adjust the virtual participant profile accordingly.

When a new user joins a session and there is already an existing virtual participant profile, the profile can either be regenerated by requesting all the subscribing users, or the virtual participant profile 126 previously generated by the processor 116 can be received through virtual profile interface 128 and provided to processor 116. In conjunction with the recently joined user profile 100, and the virtual participant profile 126, the processor 116 is able to identify the modifications to the virtual participant profile 126 needed.

If the virtual participant profile 126 is used to generate a set of suggestions, a voting process can be undertaken to allow the users to have the final decision. Results of the voting process can be fed back to the individual users profiles stored in database 118 through user profile 120. Furthermore, external information 122 that can be attributed to a particular user can be used modify the virtual participant profile 126. It may be advantageous to store such information in the individual user profile of the user associated with the external information 122. In such a case, processor 116 can send update the user profile and send the updated user profile for storage in database 118 through user profile interface 120.

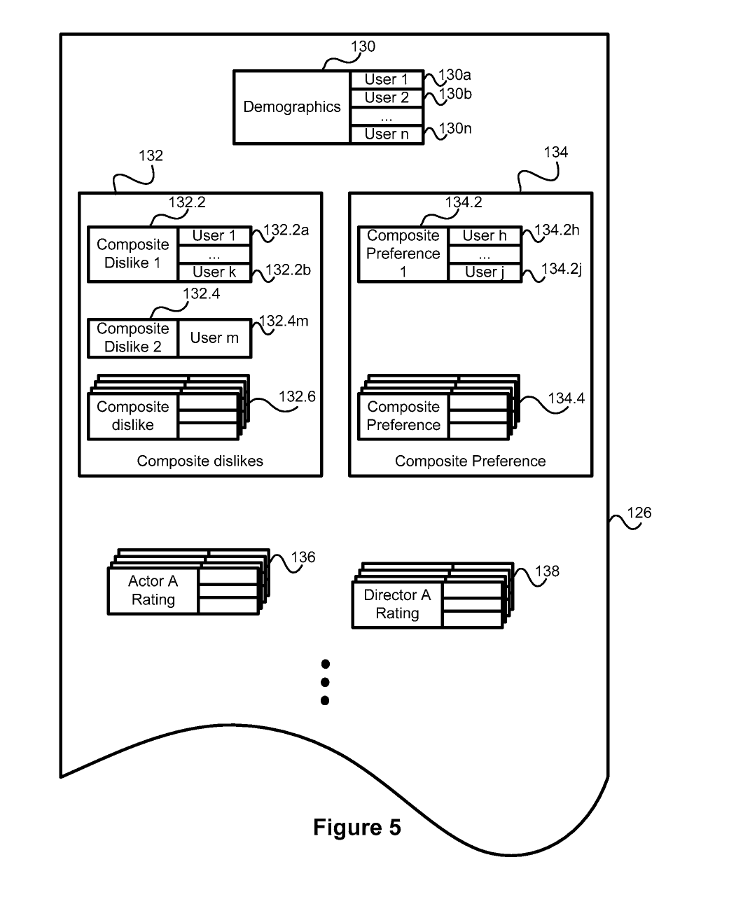

FIG. 5 illustrates an exemplary embodiment of a virtual participant profile 126. As in previous profiles, virtual participant profile 126 includes a variety of different data elements, including demographic information 130, composite dislikes 132, composite preferences 134, actor ratings 136 and director ratings 138. However, to allow for the profile 126 to be modified without requiring complete re-building of the profile 126, the contribution of each user to a particular element in the profile 126 is associated with the element in question. Thus, the composite demographic information 130 includes the user contributions 130a-130n. Not all users will necessarily contribute to each element in profile 126, and as a result, if a user leaves the event, the profile can be adjusted by removing that user's contribution to the profile. In one example, the composite dislikes 132 are made up of composite dislike 1 132.2, composite dislike 2 132.4 and a plurality of other composite dislikes 132.6. Composite dislike 1 132.2 has contributions from a plurality of users including user 1 132.2a and user k 132.2b. If user k leaves the event, his contribution to the profile can be identified and removed without requiring the processor to fetch all the user profiles 100 and to then recomputed the entire virtual participant profile 126. Similarly, composite dislike 2 132.4 is only based on the profile of user m. In this example, this may be a very strong dislike for (or an outright prohibition of) films that are subtitled. When user m leaves the event, and should no longer be contributing to the profile this composite dislike can be removed. Even if there are other contributions to the profile, they may not have a great impact due to a large number of other users that cause an averaging out of user m's other contributions. If this is the case, instead of completely recomputing the profile, the processor 116 can modify the virtual participant profile 126 by removing composite dislike 2 132.4.

Those skilled in the art will appreciate that similar modifications can occur with respect to the composite preference 1 134.2 which has contributions from user h 134.2h and user j 134.2j among others.

When a user joins the event, his or her profile elements can be added to the data structure with very little difficulty because they will simply be added as contributions. Similarly if a user profile is updated, the contribution of the user can be adjusted because any element in the profile that the user contributed to can be easily identified. The system can either remove all the contributions from the user and then re-insert them, or it can simply modify the contributions that would be affected by the change in the profile.

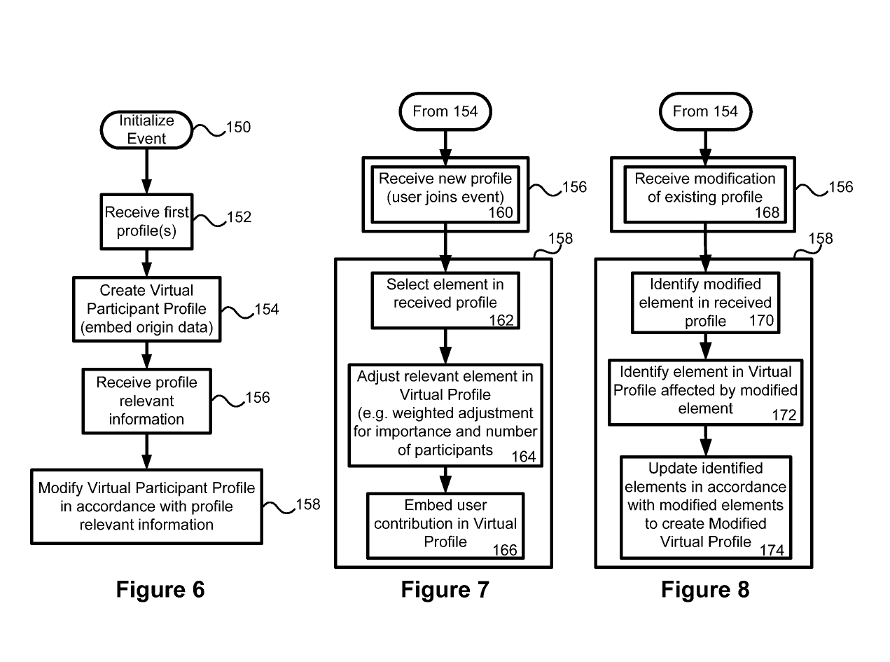

FIG. 6 illustrates a method of the present invention. In step 150, an event is initialized, and the first profile (or profiles) is received in step 152. In step 154 the virtual participant is created and the origin of the composite data is recorded. In step 156, information relevant to the virtual participant profile is received. The received information is used, in step 158, to modify the virtual participant profile generated in step 154.

One skilled in the art will appreciate that the embedding of the origin data, also referred to as indications of the individual user's contribution to the profile element, allows for modifications to the virtual participant profile without requiring all the data used to generate the profile in the first place to be assembled. This can reduce overhead associated with both data transfer and computational load.

FIG. 7 illustrates an exemplary embodiment of the method of FIG. 6, where the information relevant to the virtual participant profile is related to a new user joining the event and contributing data to be incorporated into the virtual participant profile. Following step 154 of FIG. 6, in step 156, a join request is received (step 160). This join request can be either accompanied with the profile of the user joining the event, or it can provide authorization for the joining user's profile to be retrieved from profile datastore. The modification of the virtual participant profile of step 158 is then begun by selecting an element in the received profile (the joining user's profile) in step 162. In step 164, the relevant element in the virtual profile is adjusted. This may be performed in any number of ways including by making a weighted adjustment to the virtual participant profile based on both the number of users already enrolled in the event and having contributed to the virtual participant profile, and the importance of the selected element to the joining user. In step 166, the joining user's contribution is embedded in the virtual profile. One skilled in the art will appreciate that the steps of selecting an element (step 162) and adjusting the relevant element in the virtual participant profile (step 164) could be repeated for each element in the joining user's profile.

In FIG. 8, a further alternate embodiment of the method of FIG. 6 is provided, illustrating an implementation of how to modify the virtual participant profile in step 158 as a results of receiving profile relevant information in step 156 that indicates that there has been a modification of an existing user profile that has already been incorporated into the virtual participant profile, as shown in step 168. In step 170, the modified element in the modified profile is identified. This can be done by extracting the contribution of the user in question from the virtual participant profile and comparing it to the virtual participant profile. Alternatively, it could be done by examining timestamps associated with each element in the modified profile to determine which elements have been modified since the profile was incorporated into the virtual participant profile. One skilled in the art will also appreciate that the notification of the modification could also either explicitly identify the modified elements, or include the modified elements. In step 172 an element in the virtual participant profile affected by the modified elements is identified, and in step 174 the identified element is modified to create the modified virtual participant profile. One skilled in the art will appreciate that a single modified element in the user profile may result in one or more different elements in the virtual participant profile being modified. Additionally, if there are a plurality of different elements in the user profile that have been modified, the different elements of the virtual participant profile to change can be identified and processed either in series or in parallel.

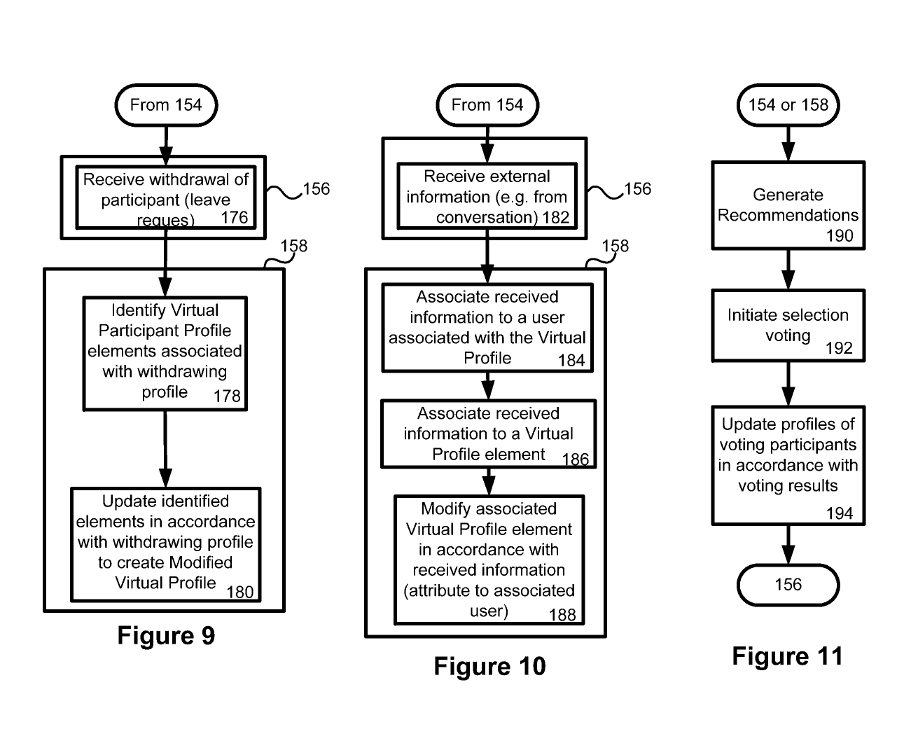

FIG. 9 illustrates an embodiment of the method of FIG. 6 where the profile relevant information received in step 156 indicates the withdrawal of a user who is already registered in the event, as shown in step 176. The modification of the virtual participant profile in step 158 commences with an identification of at least one element in the virtual profile that has a contribution associated with the withdrawing user. In step 180, the at least one identified element is updated in accordance with the withdrawing profile so that the withdrawing user's contribution is no longer reflected.

FIG. 10 illustrates an embodiment of the method of FIG. 6 where the prifle relevant information received in step 156 is not necessarily associated with an already processed profile. In step 182, external information (e.g. from a chat session associated with the event, or information associated with the event creation such as an indication that it is an action movie event) is received. The modification of the virtual participant profile in step 158 commences with the optional step of associating the received information to a user in step 184. The received information is then associated with an element in the virtual participant profile in step 186, and the associated element is modified in accordance with the received information in step 188. Where the option step 184 has been performed, an indication associating the modification to the user can be embedded in the virtual participant profile. Thus, if the information is not user specific (e.g. a theme for a movie night) it would be accounted for in the profile, but not necessarily associated with a user. If the information is obtained indicating that a particular user has said that she doesn't like a particular actor, this could be associated with the user, the relevant element in the virtual profile can be updated as appropriate. It should be understood that some of the external information associated with participants may also be reflected in the participant profile, and is preferably not doubly accounted for if a comment is made that provides redundant information.

FIG. 11 illustrates a further method that can be carried out in conjunction with any of the methods of FIGS. 6-10. Following either 154 or 158, a set of recommendations can be generated in step 190 on the basis of the characteristics of the virtual participant as embodied in the virtual participant profile. A voting process can be carried out in step 192. This voting process can be done through an IPTV terminal, through an online vote, through SMS based messaging, through email messages or through any number of other channels that will be understood by those skilled in the art. The voting process can obtain information that is relevant to the user profiles individually, not just collectively. Thus, this information can be obtained and inserted into the individual user profiles in step 194 (those skilled in the art will appreciate that this can be achieved through the use of user profile interface 120 of FIG. 4.) At this point the method can return to step 156.

One skilled in the art will appreciate that the methods illustrated in FIGS. 6-11 can be executed in parallel with each other, or can be executed in a variety of different orders without departing from the intended scope of the present invention. For example, although the steps shown in FIG. 10 are indicated as happening before the method of FIG. 11, they can also be performed while content is being consumed (or following the content consumption. In effect, steps 156 and 158 of FIG. 6 should occur after the creation of the virtual profile, but at any point in time after the creation of the profile, information relevant to the virtual participant profile can be created and provided causing step 156 to be commenced.

In some embodiments, the enrolled participants will consume the selected content at a variety of different locations. Chat functionality can be provided to the users through conventional means allowing the users to have the experience of consuming the content as a group even if geographically they are spread out. Following the consumption of the content (e.g. watching the movie) each enrolled user would have his or her profile updated to reflect the change in the viewing history, ratings for the content can also be obtained at this point and inserted into the individual user profile. These updates can be propagated through to the virtual participant profile, so that if a second movie is selected (a double feature event) the recent viewings and ratings can then be used to change the selection or suggested selections.

When users participate in an event associated with the virtual participant profile, information about the participants can be generated (e.g. voting preferences, viewing histories, movie ratings, etc.) This information can be either directly stored in the relevant individual user profile (which could then cause an update to the virtual participant profile if the profile is still active), or alternatively the information can be stored in the virtual participant profile. During the teardown of the virtual participant profile, information gathered about the users as a whole that has not been accounted for in the individual user profiles can be fed back into the profiles so that the information is available at a later moment.

It should be appreciated that a user could register for a plurality of different events. During the consumption of a first content, information about the user that is relevant to the user profile can be obtained. This information can be immediately stored in the user profile, or it can be stored in the virtual participant profile. At a variety of different times, user specific information can be moved out of the virtual participant profile and into the user profile. One such logical time is when the virtual participant profile is torn down (as discussed above), but this data could be stored in the individual profile at a variety of different times. It is possible that storing the data until the virtual participant is torn down will result in the user information not being relayed to other virtual participant profiles. As a result, it may be advantageous to update the user profile based on information collected in the virtual profile at different times. If the user withdraws from the event, the information associated with that user is removed from the virtual participant, and this could be a good opportunity to store the data back in the user profile. As another option, at the end of a movie in a multi-movie event, the information gathered about each of the users could be transferred back into the individual profiles. One skilled in the art will appreciate that a number of different scenarios could be provided without departing from the scope of the present invention.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A virtual participant profile storage for storing preferences associated with a plurality of users participating in an event, the profile storage comprising:
a memory for storing plurality of profile elements, each of the plurality of profile element storing both a composite element value determined in accordance with a corresponding element value associated with at least one of the users in the plurality of users, and an indication identifying the contribution that the at least one of the users had to the composite value.

2. The virtual participant profile storage of claim 1 wherein at least one of the plurality of profile elements is used to store information related to at least one of a composite demographic profile, a composite viewing history, a composite preference, a composite dislike, and a composite rating.

3. The virtual participant profile storage of claim 2 wherein the composite rating is associated with one of an actor, a director and a movie.

4. The virtual participant profile storage of claim 2 wherein at least one of the composite preference and composite dislike are user defined.

5. A method of generating a virtual participant profile associated with an event, the method comprising:
receiving, through a network interface, an indication that an event has been initialized;
receiving a first profile associated with both a user and the event;
creating a virtual participant profile associated with the event, the profile having both at least one profile element storing a composite value determined in accordance with an associated element in the received first profile and an indication identifying the contribution of the user associated with the first profile to the composite value; and
storing the created virtual participant profile in a memory.

6. The method of claim 5 wherein the step of receiving an indication includes:
receiving a request from a user over a network interface to initialize the event; and
creating a data structure to store data associated with the event.

7. The method of claim 5 wherein the step of receiving a first profile includes:
receiving, through a network interface from a user, confirmation of involvement in the event; and
in response to the receipt of the confirmation, retrieving from a database a user profile associated with the user associated with the received confirmation.

8. The method of claim 5 wherein creating the virtual participant profile is done in accordance with both the associated element and information associated with the event provided with the indication.

9. The method of claim 5 further including the steps of:
receiving information relevant to the stored virtual participant profile; and
modifying the stored virtual participant profile in accordance with the received relevant information.

10. A method of modifying an existing virtual participant profile representing a plurality of users and stored in a memory, the method comprising:
retrieving the stored virtual participant profile from a memory in response to receipt of information relevant to the stored profile;
identifying an element of the retrieved profile associated with the received information;
adjusting a value of the identified element in accordance with its existing value, contributions associated with at least a portion of the plurality of users and the received information; and
storing the adjusted value as part of the modified virtual participant profile in the memory.

11. The method of claim 10 wherein the received information relevant to the stored profile is a profile associated with a user joining the plurality.

12. The method of claim 11 wherein the step of adjusting further includes adjusting the value in accordance with a weighted average.

13. The method of claim 11 wherein the step of identifying includes:
determining that an element of the received user profile has no corresponding element in the retrieved virtual participant profile; and
creating an element in the virtual profile associated with the determined element in the received user profile.

14. The method of claim 10 wherein the received information relevant to the stored profile is a modification of a profile associated with a user in the plurality.

15. The method of claim 14 wherein the step of identifying includes identifying:
an element in the modified user profile that has changed; and
identifying the element in the retrieved profile associated with the changed element.

16. The method of claim 14 wherein the step of identifying includes:
determining that the modified user profile has a new element;
determining that the new element in the user profile is not associated with an element in the virtual participant profile; and
creating an element in the virtual participant profile associated with the new element in the user profile.

17. The method of claim 10 wherein the received information is an indication that a user is withdrawing from the plurality.

18. The method of claim 17 wherein:
the step of identifying includes selecting all elements in the virtual participant profile having an associated indication identifying a contribution by the withdrawing user; and
the step of adjusting includes removing the contribution associated with the withdrawing user from all selected elements.

19. The method of claim 17 further including the step of transmitting updated information associated with the profile of the withdrawing user for storage in a user profile database.

20. The method of claim 19 wherein the updated information is determined in accordance with information stored in the virtual participant profile.

21. The method of claim 10 wherein the step of adjusting the value includes associating the received information with one of the users in the plurality.

22. The method of claim 21 wherein the step of adjusting further includes storing an indication associated with the value to reflect the user in the plurality associated with the received information.

23. A virtual participant profile generator for generating and modifying a virtual participant profile associated with an event, the generator comprising:
a participant request interface for receiving from users request to join or leave the event;
a user profile interface for communicating with a user database storing user profiles; and
a processor for generating the virtual participant profile in response to receipt of a user request to join the event in accordance with receipt of a user profile associated with the requesting user, the generated profile storing an indication of user contribution to at least one element of the profile, and for modifying an already generated virtual profile in accordance with a second user request to join an event or a user request to withdraw from an event.

24. The virtual participant profile generator of claim 23 further including an external data interface for receiving information relevant to the virtual participant profile, and for transmitting the received information to the processor.

25. The virtual participant profile generator further including a virtual profile interface for receiving an already generated virtual participant profile and for transmitting the received profile to the processor for modification.
